(19) United States
(12) Patent Application Publication
(10) Pub. No.: US 2006/0189351 A1
(43) Pub. Date: Aug. 24, 2006

(54) Radio frequency switch device

(75) Inventors: Seong-Taek Hwang, Pyeongtaek-si (KR); Jae-Hoon Lee, Seoul (KR); Moon-Il Kim, Seongnam-si (KR); Ji-Chai Jeong, Seoul (KR); Jong-Kuck Son, Yeongcheon-si (KR)

Correspondence Address: CHA & REITER, LLC, 210 ROUTE 4 EAST STE 103, PARAMUS, NJ, 07652, US

(73) Assignee: Samsung Electronics Co.; LTD

(21) Appl. No.: 11/156,152

(22) Filed: Jun. 17, 2005

(30) Foreign Application Priority Data
Feb. 21, 2005 (KR) 2005-14183

(51) Int. Cl. H04B 1/38; H04M 1/00

(52) U.S. Cl. 455/560

(57) ABSTRACT

A radio frequency switch is disclosed. The switch includes a plurality of first substrates in which a ground surface is formed on each of the first substrates and a micro-strip line and a semiconductor on/off switch are disposed on a plane surface of the ground surface, a plurality of second substrates in which a ground surface is formed on each of the second substrates and a micro-strip line is disposed on a plan surface of the ground surface, the second substrates being combined with the first substrates so as to cross each other and being electrically connected to the first substrates, and combining means for combining the first and second substrates so as to cross each other.

### CLAIM OF PRIORITY

This application claims the benefit of the early filing date pursuant to 35 USC §119 to that patent application entitled “Radio Frequency Switch Device,” filed in the Korean Industrial Property Office on Feb. 21, 2005 and assigned Ser. No. 2005-14183, the contents of which are hereby incorporated by reference.

### BACKGROUND OF THE INVENTION

1. Field of the Invention

The present invention relates to a switching device and more specifically to a radio frequency switch device that includes substrates assembled while crossing each other.

2. Description of the Related Art

As frequency resources are restricted and users demand various multimedia services, base stations employ optical cables having broadband characteristics, excellent frequency characteristics, and low loss characteristics to provide such multimedia services. Base stations may also use distributed antenna systems (hereinafter, referred to as DAS) which are now being developed, to provide additional capability. In conjunction with optical cables and distributed antenna systems, communication systems are be developed that maximize the frequency reuse by applying small cell radii and radio over fiber (hereinafter, referred to as RoF) technology that can provide further broadband radio services.

Since the RoF technology adopts advantages of optical communication technologies providing broadband capability and radio communication technologies providing mobility, RoF is also suitable for development of multi-access optical networks that integrate wire and wireless communication technologies.

The RoF technology can also provide broadband radio multimedia services at hypervelocity, as well as can constitute communication services infrastructures for intelligent transport systems (ITS) of bandwidth of at least 5.8 GHz and communication transmitters having bandwidth in the range of 0.7 to 2.5 GHz. The RoF technology is expected to be used as an alternative to radio technologies that can provide hypervelocity broadband services regardless of place and kind of terminal, even in ubiquitous networks which are expected to be introduced in the near future.

Since the RoF technology is combined with expensive RF equipments, such as radio frequency switch systems and amplifiers, which are used in existing base stations and with central base stations, referred to as central control centers, a broadband radio frequency switch capable of controlling channels and services which are transmitted to several DAS according to a communication environment is required of the RoF technology.

A conventional radio frequency switch, as shown in FIG. 1, is not suitable to control many DAS in groups with a small space and a minimum expense.

Conventional and commonly used radio frequency switches, such as that shown in FIG. 1, include mechanical and semiconductor devices. Mechanical switches have good insertion losses and good insulation properties, but have a disadvantage in that their size is large. On the other hand, radio frequency switches that use semiconductor devices have an advantage in that their size is quite small, but have disadvantages in that insertion losses and insulation properties are not good.

As shown in FIG. 1, broadband characteristics and high outputs can be guaranteed by applying a coaxial switch which determines on/off states of the mechanical radio frequency switch.

However, in a case the mechanical radio frequency switch is applied to the RoF, the volume of the resultant device is relatively large in comparison with the number of DAS that can control one radio frequency switch.

In order to settle the above-mentioned disadvantage of the mechanical radio frequency switch, RoF technology employs a radio frequency switch la (see FIG. 2) using semiconductor devices that are very small and cheap. The radio frequency switch 1a (which uses the semiconductor devices) needs a narrow interval between base stations and is electrically operated so that the switch is operated with a small output power.

Further, with to the development of the semiconductor technology, chips, which can use wide frequency bandwidths of over 0.7 to 2.5 GHz of a transmitter (not shown) and a median power source of a few watts, are commonly used. Therefore, if the radio frequency switch la as shown in FIG. 2, is used, a substrate 3 including 4-way power combiners are connected to output terminals connected to 8-way power dividers 2, and therefore a 4×8 radio frequency switch module 1a which enables selective transmission is constituted.

The eight substrates 2 and the four substrates 3 are connected to each other by using sub miniature assembly (e.g., SMA) adapters 4, and SMA connecters 5 and SMA cables 6 are provided in the substrates 2 and 3 respectively.

However, since the conventional radio frequency switch includes expensive parts such as the SMA connecters, the SMA adapters, and the SMA cables to combine the substrates, it has a disadvantage in that the manufacturing cost is expensive.

Further, since the 4 by 8 radio frequency switch uses SMA connectors to combine the eight substrates with the four substrates, the cost for the sixty four SMA connectors, i.e., 8×4×2, and the thirty two SMA connectors, i.e., 8×4, which are required to combine the substrates is expensive. Furthermore, since the four output terminals of the power dividers should be engaged simultaneously to properly combine the substrates, the assembling process of the substrates is difficult. Considering the sizes of the SMA adapters and the SMA adapters, it is difficult to decrease the intervals between the output terminals of the eight substrates and the four substrates to under 20 mm, and thus the overall size of the product cannot be reduced, blocking the minimization thereof.

### SUMMARY OF THE INVENTION

Accordingly, the present invention has been made to solve the above-mentioned problems occurring in the prior art and provides additional advantages, by providing a radio frequency switch device which can reduce and minimize the size of the product by combining substrates so as to cross each other.

It is another aspect of the present invention to provide a radio frequency switch device which can reduce the manufacturing cost thereof, and thereby can improve assembling processes thereof, by combining the substrates so as to cross each other and thus excluding the existing parts for combining the substrates.

In order to accomplish these objects, there is provided a radio frequency switch including: a plurality of first substrates in which a ground surface is formed in each of the first substrates and a micro-strip line and a semiconductor on/off switch are disposed on a plan surface of the ground surface; a plurality of second substrates in which a ground surface is formed in each of the second substrates and a micro-strip line is disposed on a plane surface of the ground surface, the second substrates being combined with the first substrates so as to be substantially orthogonal to and being electrically connected to the first substrates; and combining means for combining the first and second substrates so as to be substantially orthogonal to each other.

### BRIEF DESCRIPTION OF THE DRAWINGS

The above objects, features and advantages of the present invention will be more apparent from the following detailed description taken in conjunction with the accompanying drawings, in which:

FIG. 1 is a perspective view for showing a structure of a conventional radio frequency switch;

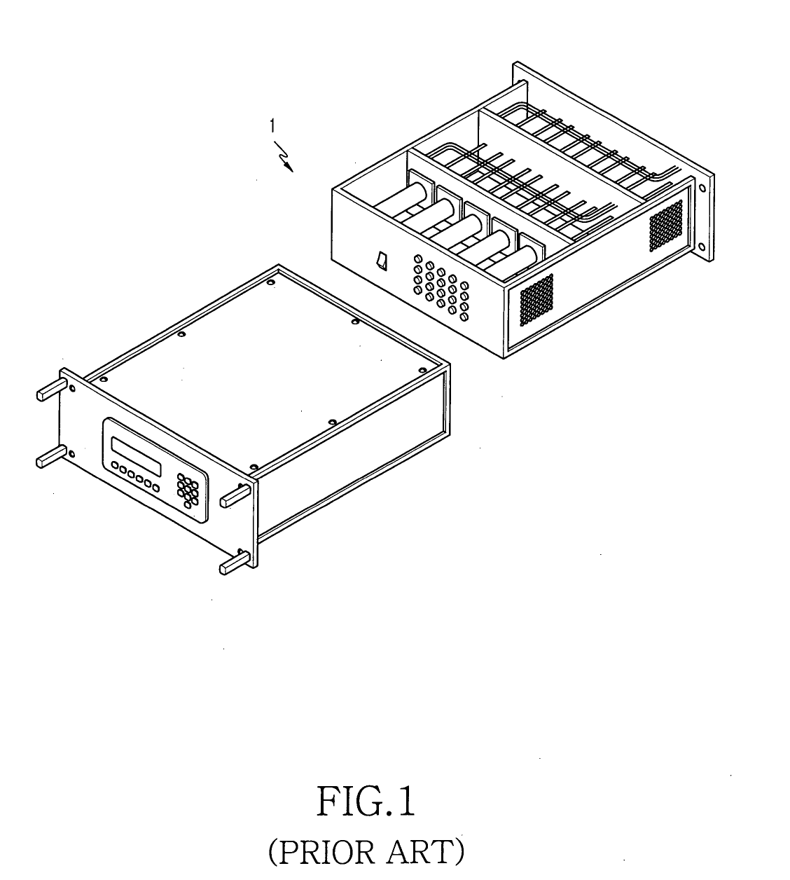

FIG. 2 is a perspective view for showing a combining structure of a conventional radio frequency switch;

FIG. 3 is a perspective view for showing a structure of a radio frequency switch according to a preferred embodiment of the present invention;

FIG. 4 is a perspective view for showing a combining state of a radio frequency switch according to a preferred embodiment of the present invention;

FIG. 5 is a side view for showing substrates of a radio frequency switch according to a preferred embodiment of the present invention;

FIG. 6 is a plan view for showing a combining state of a radio frequency switch according to a preferred embodiment of the present invention;

FIG. 7 is a perspective view for showing a radio frequency switch according to a preferred embodiment of the present invention;

FIG. 8 is a graph for showing measuring results of a radio frequency switch according to a preferred embodiment of the present invention;

FIG. 9 is a graph for showing insertion losses of frequencies of a radio frequency switch according to a preferred embodiment of the present invention; and

FIG. 10 is a graph for showing return losses of frequencies of a radio frequency switch according to a preferred embodiment of the present invention.

### DETAILED DESCRIPTION

Hereinafter, embodiments of the present invention will be described with reference to the accompanying drawings.

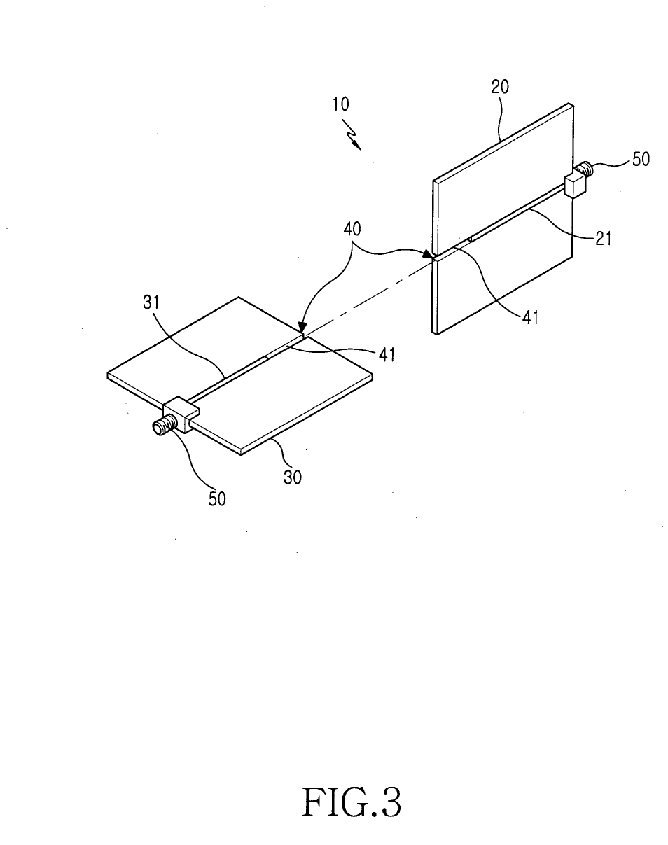

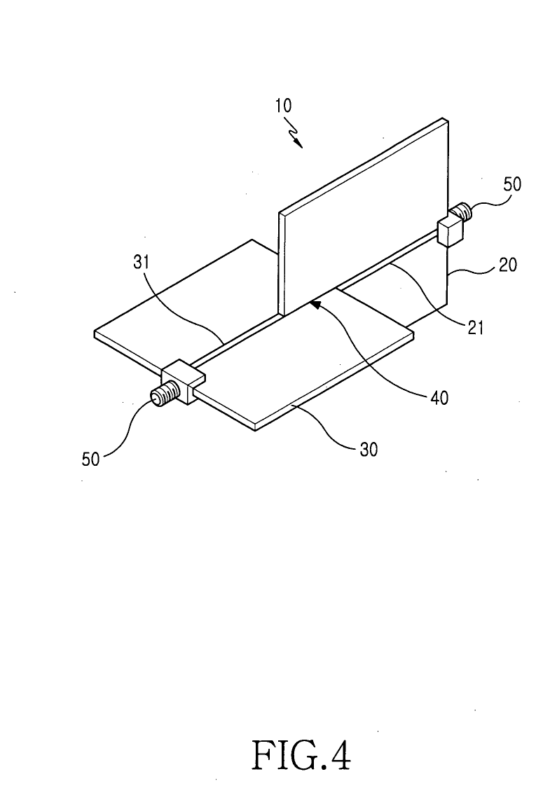

As shown in FIGS. 3 and 4, a radio frequency switch 10 according to the present invention includes a plurality of first substrates 20, a plurality of second substrates 30, and a combining means 40. The first substrate 20 forms a ground surface. A micro-strip line 21 and a semiconductor on/off switch (not shown) are disposed on a flat surface of the ground surface thereof. The second substrate 30 also forms a second ground surface, and micro-strip line 31 is disposed on a flat surface of the ground surface thereof. The second substrate 30 is combined with the first substrate 20 so as to be substantially orthogonal to, or cross, and are electrically connected to each other. The combining means 40 is formed so as to allow first and second substrates 20 and 30 to cross each other.

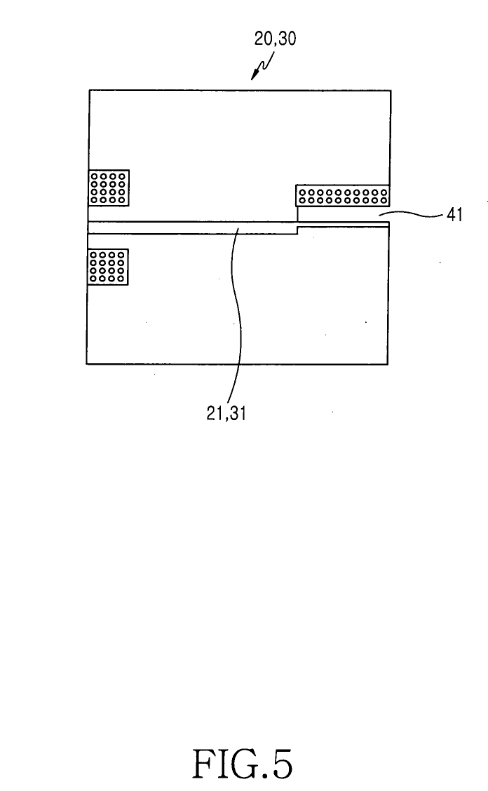

FIG. 5 illustrates a plane view of an exemplary substrate representative of first substrate 20 or second substrate 30. As shown in FIG. 5, the combining means 40 has an insertion portion 41 at one end of each of the substrates 20 and 30 so that the substrates 20 and 30 are inserted into each other to be combined with each other (see FIG. 4). An insertion recess 41 having a thickness substantially of each of the substrates 20 and 30 and a predetermined depth is formed in the corresponding insertion portion 41. The insertion recess 41 of the combining means 40 is formed at one end of each of the substrates 20 and 30.

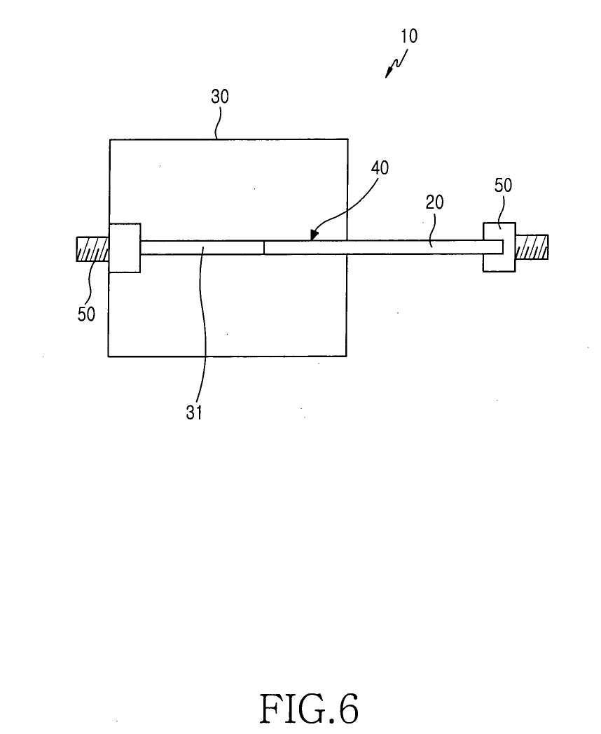

FIG. 6 illustrates a plane view of the switch in accordance with the principles of the invention. In this illustrated view, substrate 30 lies in the plane of the drawing sheet and substrate 20 lies in a plane substantially perpendicular to the plane of the drawing sheet. Hence substrate 20 is viewed on edge. As shown in FIG. 6, a SMA connector 50 is provided at the other end of each of the substrates 20 and 30.

Returning to FIG. 4, it is illustrated how the first and second substrates 20 and 30 are combined with each other via respective insertion portions 41 as that substrate 20 and 30 cross each other at substantially right angles, i.e., 90 degrees.

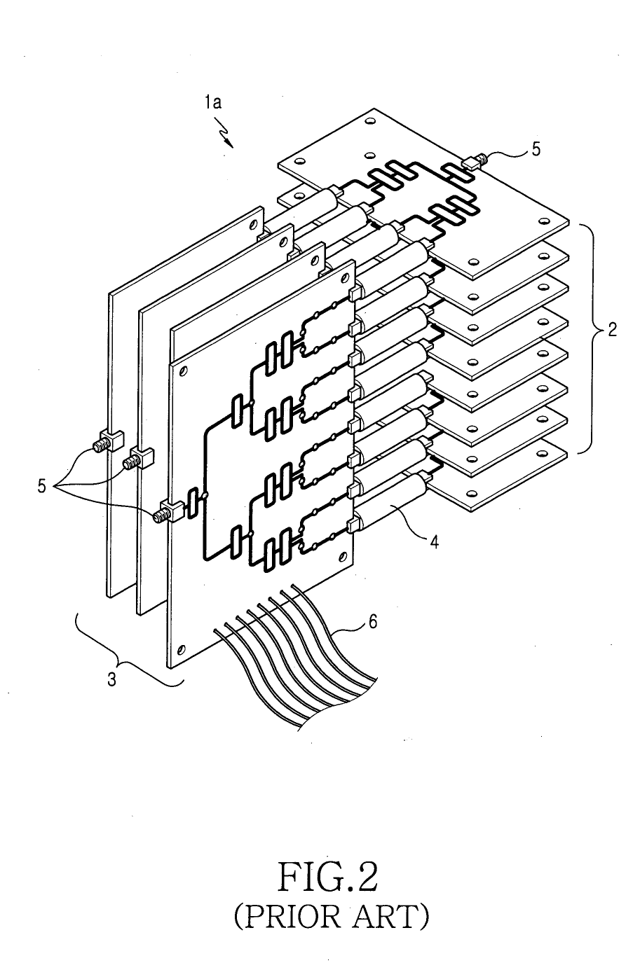

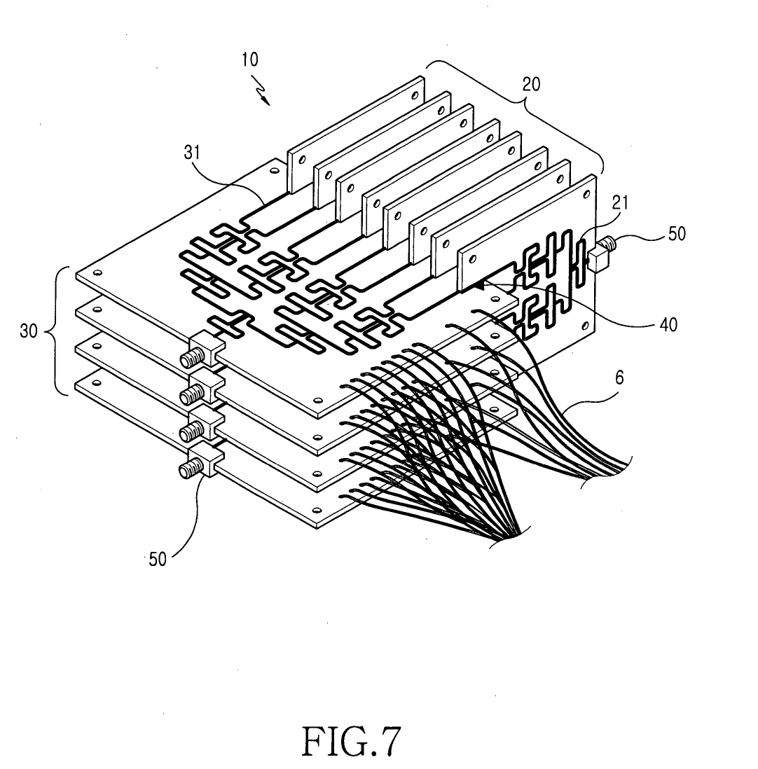

FIG. 7 illustrates an exemplary 4×8 switch in accordance with the principles of the invention. As shown in FIG. 7, eight (8) first substrates 20 are connected to four (4) second substrates 30 to form a 4×8 switch similar to that shown in FIG. 2. It would be recognized that 8-way power dividers (not shown) and semiconductor on/off switches (not shown) are provided in the substrates 20, and 4-way power combiners (not shown) are provided in the substrates 30 to provide for control and distribution of the provided input signals.

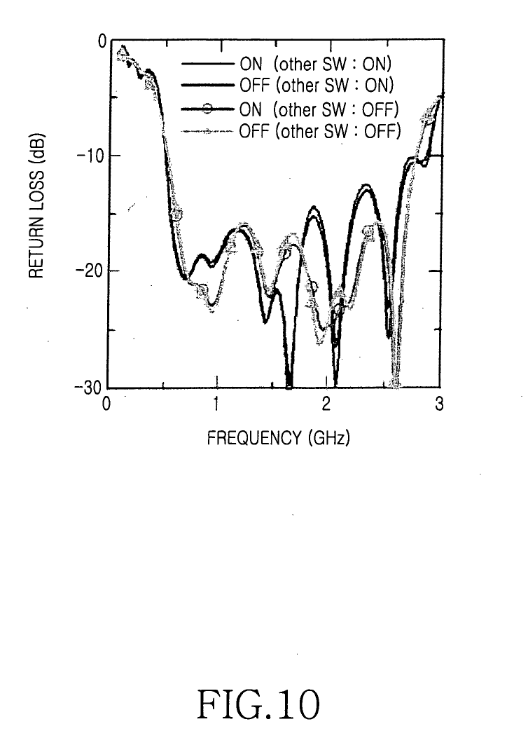

Hereinafter, the operation of the radio frequency switch according to the above-mentioned preferred embodiment of the present invention will be described with reference to FIGS. 3 to 10.

As shown in FIGS. 4 to 7, in the radio frequency switch device 10, the first substrates 20 providing 8-way power dividers are combined with the second substrates 30 providing 4-way power dividers so as to cross each other.

As shown in FIG. 3, since the insertion recess 41 having a thickness of each of the substrates 20 and 30 and a predetermined depth is formed at one end of each of the substrates 20 and 30, the insertion recess 41 formed in the first substrate 20 and the insertion recess 41 formed in the second substrate 30 are inserted into and combined with each other to cross each other.

Then, as shown in FIGS. 6 and 7, the ground surfaces are formed in the first and second substrates 20 and 30, and the micro-strip lines 21 and 31 are disposed on the flat surfaces of the ground surfaces of substrates 20 and 30, respectively. The first and second substrates 20 and 30 are combined with each other so as to cross each other at substantially right-angles. The substrates are further electrically connected to each other via the micro-strips 21 and 31.

In one aspect of the invention, the combined portions of the substrates 20 and 30 are soldered.

By disposing the first and second substrates at substantially right angles, the size of the radio frequency switch device 10 can be reduced. Further, by reducing the number of the combining parts of the substrates, the manufacturing cost of the radio frequency switch device 10 can be reduced.

In order to confirm whether high frequency bandwidths of a communication transmitter (not shown) and the RoF technology can be used, measured data of return losses and insertion losses in the range of 0.1 to 8.5 GHz, in comparison with micro-strip lines 21 and 31 of 50Ω, are obtained.

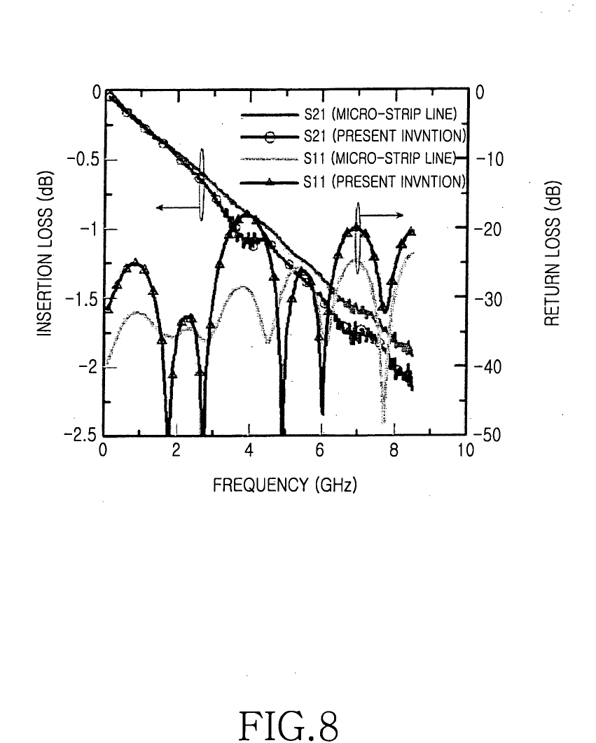

Referring to FIG. 8, the insertion losses in the measured data of the radio frequency switch device according to the present invention are as follows.

In comparison with the micro-strip lines 21 and 31, the present invention has a little degeneration at the bandwidth of 40 Ghz, but shows an excellent characteristics at under −17 dB.

Furthermore, the return losses in the measured data of the radio frequency switch device according to the present invention are as follows.

In comparison with the micro-strip lines 21 and 31 considering dielectric losses, the return losses of the present invention are almost the same as those of the micro-strip lines at the bandwidths of under 2.5 GHz which correspond to a transmitter and are different from those of the micro-strip lines at the bandwidths of over 3 GHz by about 0.3 dB.

The intervals between the output terminals can be reduced to 10 mm by combining the substrates 20 and 30 with each other at the combining means 40 of the radio frequency switch device 10. The intervals can be reduced more if thin substrates of high dielectric constant are used.

As shown in FIG. 7, the output terminals which can transmit signals from the four substrates (channels) to the eight substrates (DAS) 20, can divide the thirty two signals into eight signals equally and provide equal outputs in real time. Further, the channels to be provided in the output terminals can be selectively controlled by the operation of the on/off switch (not shown).

The radio frequency switch device 10 shows an insertion loss of −16.5 dB to −19.5 dB at a transmitter bandwidth of in the order of 2 GHz (e.g., 0.7 to 2.5 GHz).

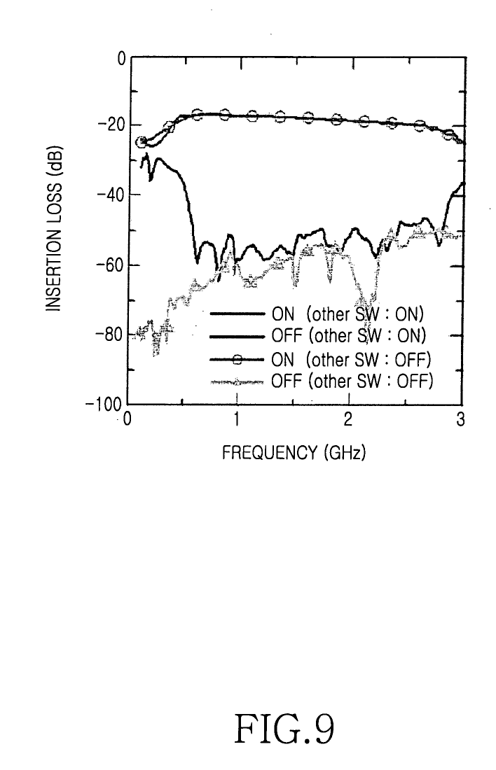

As shown in FIG. 9, when the on/off switch is off, the radio frequency switch shows good isolation characteristics of under −48.1 dB at the transmitter bandwidths, regardless of the operations of the other on/off switches.

As above-described, according to the present invention, by combining the substrates at substantially right angles, the size of the device can be reduced and minimized. Further, since the existing parts (SMA cables, SMA connectors, and SMA adapters, etc.) for combining the substrates are not necessary, the radio frequency switch can be manufactured with low expenses and therefore, cope with the communication environment activity.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. A radio frequency switch comprising:
a plurality of first substrates in which a ground surface is formed in each of the first substrates and a micro-strip line and a semiconductor on/off switch are disposed on a plan surface of the ground surface;
a plurality of second substrates in which a ground surface is formed in each of the second substrates and a micro-strip line is disposed on a plan surface of the second substrate ground surface, the second substrates being combined with the first substrates so as to cross each other and being electrically connected to the first substrates; and
combining means for combining the first and second substrates so as to cross each other.

2. A radio frequency switch according to claim 1, wherein the combining means comprises insertion portions at one end of each of the substrates to insert the substrates into each other.

3. A radio frequency switch according to claim 2, wherein each of the insertion portions comprises a insertion recess of a thickness of the substrate and a predetermined depth.

4. A radio frequency switch according to claim 1, wherein an insertion recess of the combining means is formed at one end of each of the substrates and an SMA connector is provided at the other end of each of the substrates.

5. A radio frequency switch according to claim 1, wherein the first and second substrates are combined with each other so as to be cross each other at substantial right angles.

6. A radio frequency switch according to claim 1, wherein 8-way power dividers are provided in the first substrates and 4-way power combiners are provided in the second substrates.

7. A radio frequency switch comprising:
a plurality of substrates in which a ground surface is formed in each of the substrates and a micro-strip line is disposed on a plan surface of the ground surface, the substrates being combined with each other so as to cross each other and being electrically connected to each other; and
combining means for combining the substrates so as to cross each other.

8. A method for constructing a radio frequency switch comprising:
forming at least one first substrate having a micro-strip line and a semiconductor switch disposed on a plan surface of a ground surface on said first substrate and further including a recess suitable as an insertion portion;
forming at least one second substrate having a micro-strip line disposed on a ground surface of said second substrate and further including a recess suitable as an insertion portion; and
fitting said at least one first and at least second substrate together through corresponding ones of said insertion portions, wherein said first and second substrates are substantially orthogonal to each other.
